(19) United States
(12) Patent Application Publication
(10) Pub. No.: US 2013/0144727 A1
(43) Pub. Date: Jun. 6, 2013

(54) COMPREHENSIVE METHOD AND APPARATUS TO ENABLE VIEWERS TO IMMEDIATELY PURCHASE OR RESERVE FOR FUTURE PURCHASE GOODS AND SERVICES WHICH APPEAR ON A PUBLIC BROADCAST

(71) Applicants: Jean Michel Morot-Gaudry, Fullerton, CA (US); Christopher Michael Roselli, Irvine, CA (US)

(72) Inventors: Jean Michel Morot-Gaudry, Fullerton, CA (US); Christopher Michael Roselli, Irvine, CA (US)

(21) Appl. No.: 13/312,790

(22) Filed: Dec. 6, 2011

(51) Int. Cl. G06Q 30/06; G06Q 30/02; H04N 21/2547

(52) U.S. Cl. 705/14.72; 725/32

(57) ABSTRACT

A comprehensive organization entertainment and purchasing operating system through a computer network. A Front End allows users viewing, purchasing, social networking and the like. A back end of the system, includes maintaining relationships with content providers who produce and cause to be broadcast a media source of in a public venue such as television, movies, streaming videos, and video games etc. and further highlighted and display products and services in numerous scenes. Information on content partners including contact information of key decision makers at major studios, mini-majors and independent film makers which is entered into the system's computer database. The system will also include granting access to key content partners so that interactions with content partners can include uploading content to encoding, providing digital distribution contracts with the system's corporate legal department, uploading information to the corporate heads of the system, and maintaining a multilayered content management system.

### BACKGROUND OF THE INVENTION

1. Field of the Invention

The present invention is related to the field of on-line commerce by which product and service providers arrange to have their specific product or service placed in selected scenes of a public broadcast so that viewers can see the specific product or service worn by a popular actor or actress or used in a scene such as an automobile chase.

2. Description of the Prior Art

One source of advertising a company's product or service is product placement in a scene of a pubic broadcast such as a motion picture, television show, streaming video, podcast, etc. in order to provide wide pubic visibility for consumers to view the product and/or service in a scene so that a person will be motivated to buy the product, make reservations at a restaurant, resort or spa, or otherwise arrange to acquire what is widely displayed on a public venue.

There are numerous types of sales of product in on-line venues such as searching a product on a search engine, buying a product through an internet conducted auction, etc. However, the present online purchasing forums usually do not enable an individual to view a product as part of a media broadcast except for product placement spots which do not afford the individual the ability to purchase a product that the individual sees and likes.

There is a significant need to enable an individual to purchase a product or service which appears on a media broadcast based on impulse buying or because the product is presented in a particularly attractive way when used in a scene.

### SUMMARY OF THE INVENTION

The present invention has many advantages over prior art e-commerce applications which simply display a product through various technological applications to provide a means for an individual to purchase a product displayed in a public broadcast.

The present invention is a completely comprehensive organization operating system through a computer network that has a complete operating system. A first key component is described as a back end of the system which includes maintaining relationships with content providers who produce and cause to be broadcast a media source of entertainment in a public venue such as television, movies, streaming videos, and video games etc. and display products and services in numerous scenes. This will include all available information on content partners including contact information of key decision makers at major studios, mini majors and independent film makers which is entered into the system's computer database. A profile is created for each key decision maker. The system will also include granting access to key content partners so that interactions with content partners can include uploading content to Encoding, providing digital distribution contracts with the system's corporate legal department, uploading information to the corporate heads of the system, and maintaining a multilayered content management system. The present invention also includes computerized business relationships with product partners and service partners that arrange to have their respective products or services appear in one or more selected scenes in a broadcast medium. The system includes content information pertaining to key decision makers of the product and service vendor partners which is stored in the system database and a profile of each is created so that the profile of each key decision maker and the products and services they provide is stored in the database.

A second very key component in the back end of the present invention system is a completely computerized encoding of every single product and every single service placed in every single scene of each and every media venue publicly broadcast in any way so that anyone wishing to purchase any product or service which is depicted in any way in any scene in any one of the public media venues can do so with a minimum of effort and inconvenience and can do so with complete accuracy to assure that they are purchasing what they have requested to purchase when they view the product or service depicted on the public venue.

The public venues include but are not limited to movies, television, sports, fashion shows, music, games, social events and coming attractions. The encoding is a business process wherein the content is stored on the system corporate server and delivered by means such as a content delivery network to at least one single device agnostic account. Content can be defined as the menu option on the home page of the server or any other domain name owned and selected by the system owner.

The back end of the present invention system further comprises the following sections: (1) a corporate department including legal affairs, business development, public relations and marketing, and affiliate partnership managers; (2) an operations department including a chief operating officer; (3) a customer relationship department which includes account managers, customer service and fraud prevention; (4) partnership with shipping managers for drop shipping of buyer's product and services managers and (5) a content acquisition department including a user experience division.

The back end of the present invention system supports the front end which includes interaction with the users and purchasers of the products and services depicted on the various media scenes. The present invention multilayer content management system has eight main functions in the business process of the present invention system which include: (1) maintaining developer code and security; (2) managing administration objects; (3) managing content such as movies, television, sports, fashion shows, music, games social events, coming attractions and services; (4) managing product partner interface; (5) managing service partner interface; (6) managing the quality of the user experience; (7) Meta Data and (8) Hyper Meta Data.

The present invention content management system is a system providing a collection of procedures used to manage work flow in a collaborative environment. These procedures are preferably computer based however a hand written back is optional. The procedures are designed to do the following: (1) allow for a large number of people to contribute to and share stored data; (2) control access to data based on user roles (defining which information users or user groups can view, edit, publish etc.); (3) aid in easy storage and retrieval of data; (4) reduce repetitive duplicate input; (5) improve the ease of report writing and (6) improve

communications between the system of the present invention and the content, product and service partners.

In the present invention content management system, the stored data can be anything. The system will have a built in redundancy backup of at least two inputs minimum wherein documents, movies, pictures, phone numbers, scientific data etc. are inputted into multiple servers. The content management system computer server or servers are used for storing, controlling revising, semantically enriching, and publishing documentation. Serving as a central repository, the content management system increases the version level of new updates to an already existing file. Version control is one of the primary advantages of the present invention system.

Included in the content management system is information referred to as a Meta Data includes information about the product such as a movie, the studio which produced the movie, the director, producer, cast and a synopsis of the movie.

Also included in the content management system is Hyper Meta Data which includes products, services, photos, gossip and any other related information that the system provider determines is relevant. Within a scene, the Hyper Meta Data could include products placed in the scene such as a sports car, bracelet, beaded necklace, dress, sunglasses and a handbag.

At the user portion of the present invention, the user will have to be registered with the system provider, the registration including the authorized user's name, billing address, shipping address, encrypted password, credit verification and at least one credit card which has been pre-approved to a certain limit for purchase. As additional security, the content delivery network will have an ever changing web address, encryption and privacy protection.

In step 1, the user logs in and provides the user' name and password and arrives at a home page. The user selects the content tab such as Movie and then selects a particular movie. In Step 2, the user plays the movie or watches a trailer. The user selects viewing options of low, medium, high definition or 3D. The viewer has the option to select chapters and expand to full screen and then which the movie.

A fundamental key innovation of the present invention is the cue point to purchase and pause to purchase option. The user utilizes a remote control, computer mouse, voice command, gesture command or other enabling device to pause the running of the media broadcast such as a movie or television show, select an item from a scene, move the item to a checkout window and specify the product including information about the product such as dress size, color, etc. Micro transactions within the content are processed and/or T-commerce is completed. The user pays for the product and by pre-registration, the system provider is advised where to bill and where to ship the product. The process to deliver the product to the user is then set in motion. The user then ends the pause and continues watching the media event.

An alternative fundamental innovation of the present invention is the cue point to pause and research where the user utilizes a remote control, computer mouse, voice command, gesture command or other enabling device to pick out an item from a scene and have it stored in a separate file. The movie continues running and after the movie is completed, the user goes to the storage file to determine whether or not the user wishes to purchase the item and if the user wishes to purchase the item, then the same process is followed to enable the user to selected specifics about the product and arrange for its payment and shipment.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is an illustration summarizing in chart form the major components of the present invention;

FIG. 2 is an illustration describing the content partners and product and service providers in detail;

FIG. 3 is an illustration depicting the encoding of all data for the present invention;

FIG. 4 is an illustration of the back end corporate operations of the present invention;

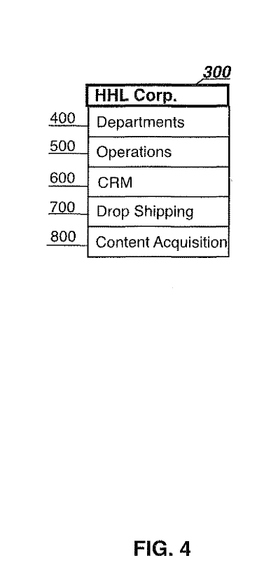

FIG. 5 is an illustration of the present invention multi-layer content management system;

FIG. 6 is an illustration of the Meta-Data function of the present invention;

FIG. 7 is an illustration of the Hyper Meta Data function of the present invention;

FIG. 8 is an illustration of the back end and front end of the present invention;

FIG. 9 is an illustration of the present invention content management system;

FIG. 10 is a flow chart illustrating a user log-in and viewing process;

FIG. 11 is an illustration of a scene viewed by a user and selecting portions of the scene to stop, pause and purchase a product from the scene;

FIG. 12 is a flow chart illustrating the Cue Point to purchase function of the present invention;

FIG. 13 is a detailed flow chart illustrating Cue Point-to-Purchase and sharing the information with another party;

FIG. 14 is connecting users emotionally; and

FIG. 15 is pause and Gift.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

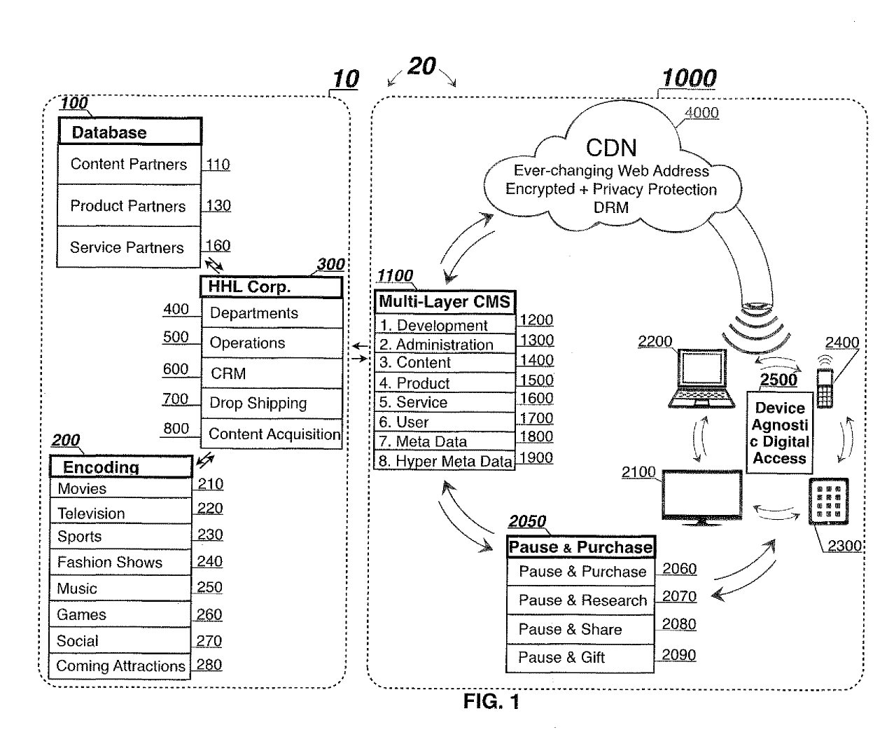

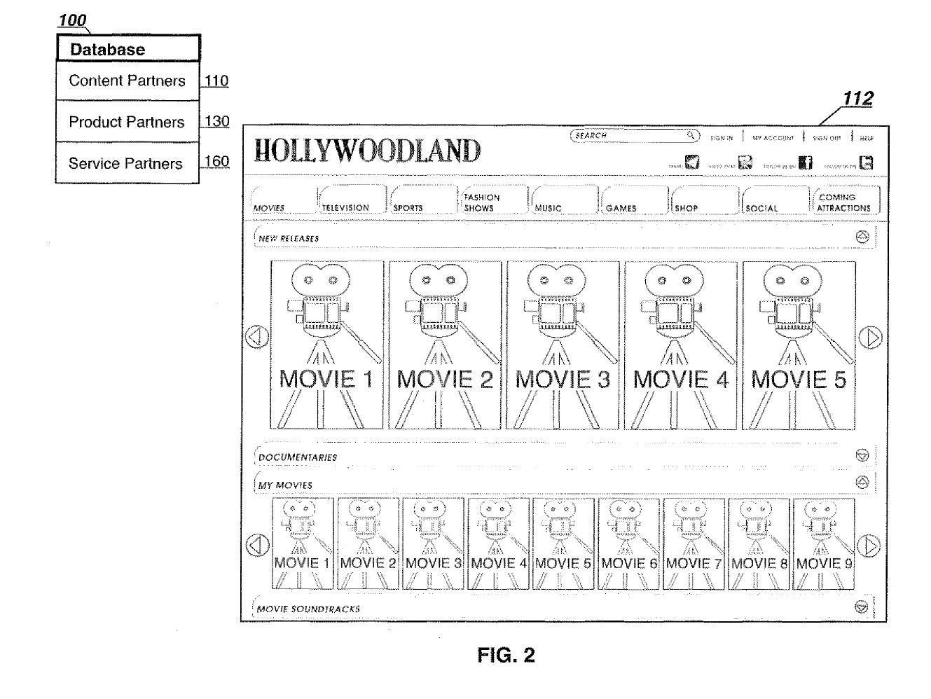

Referring to FIG. 1, there is illustrated an illustration summarizing the major components of the present invention. The present invention is a completely comprehensive organization operating system through a computer network that has a complete operating system. A first key component is described as a back end of the system designated by the numeral 10 which includes a company database 100 which summarizes the categories in the database 100 includes maintaining relationships with content partners 110 who produce and cause to be broadcast a media source of entertainment in a public venue such as television, movies, streaming videos, playing video games etc. and display products and services in numerous scenes. FIG. 2 is an illustration describing the content partners and product and service providers in detail for purchasing by the user. Also attached is a screen shot of a graphic user interface illustrating menu options at the top of a screen, such as a multiplicity of movies 112 from which the user can make a selection. This will include all available information on content partners 110 including contact information of key decision makers at major studios, mini majors and independent film makers which is entered into the system's computer database. A profile is created for each key decision maker. The system will also including granting access to key content partners so that interactions with content partners can include uploading content to Encoding, providing digital distribution contracts with the system's corporate legal department, uploading information to the corporate heads of the system, and maintaining a multilayered content management system. The present invention also includes computerized business relationships with product providers 130 and service providers 160 that arrange to have their respective products or services appear in one or more selected scenes in a public broadcast medium. The system includes content information pertaining to key decision makers of the product and service vendor partners which is stored in the system database and a profile of each is created so that the profile of each key decision maker and the products and services they provide is stored in the database.

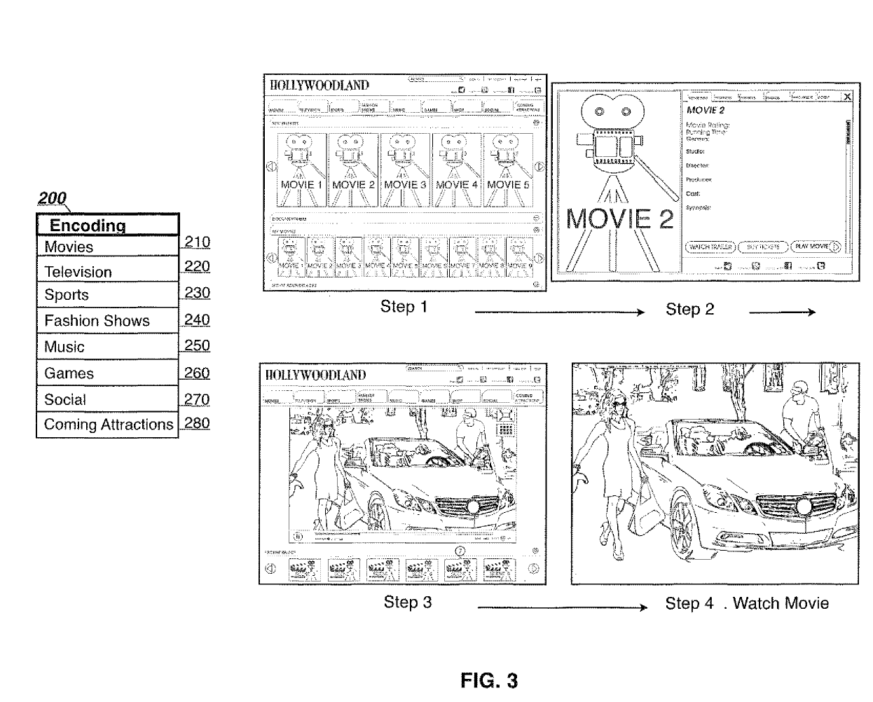

Referring to FIGS. 1 and 3, a second very key component in the back end 10 of the present invention system is a completely computerized encoding 200 of every single product 130 and every single service 160 placed in every single scene of each and every media venue publicly broadcast in any way so that anyone wishing to purchase any product or service which is depicted in any way in any scene in any one of the public media venues can do so with a minimum of effort and inconvenience and can do so with complete accuracy to assure that they are purchasing what they have requested to purchase when they view the product or service depicted on the public venue.

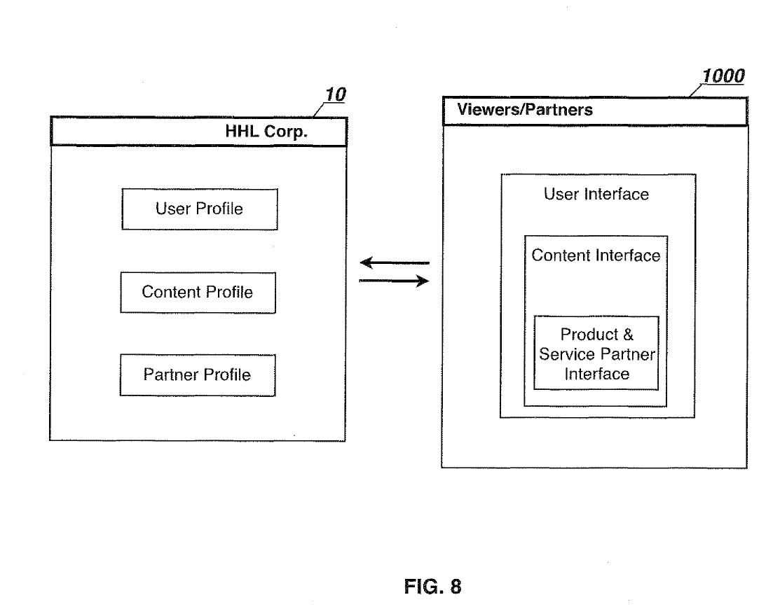

The public venues include but are not limited to movies 210, television 220, sports 230, fashion shows 240, music 250, games 260, social events 270, corning attractions 280, shopping and the like. The encoding 200 is a business process wherein the content is stored on the system corporate server and delivered by means such as a content delivery network 4000 to at least one single device agnostic account 2500. Content can be defined as the menu option on the home page of the server or any other domain name owned and selected by the system owner. In step 1 the consuming user previously created an account see FIG. 8 logs into the system 20 with username and password and arrives at Home page. Tabs on the Home page are available to be selected for example the user selects content tab Movie and the available movies are shown on the screen, the user may then select a movie for more information. In step 2 the user has the option to play a trailer of the movies or to play the entire movie, or to go back to previous menu. In step 3 the user is provided with options to select chapters of the movie, expand to full screen, choose viewing quality of low, medium, HD or 3D and other viewing options. In Step 4 the user watches the movie based on the viewing options selected.

Referring to illustrations 1 and 4, the back end 300 of the present invention system further comprises the following sections: (1) a corporate department 400 including legal affairs, business development, public relations and marketing, and affiliate partnership managers; (2) an operations department 500 including a chief operating officer; (3) a customer relationship department 600 which includes account managers, customer service and fraud prevention; (4) partnership with shipping managers 700 for drop shipping of buyer's product and services managers; and (5) a content acquisition department 800.

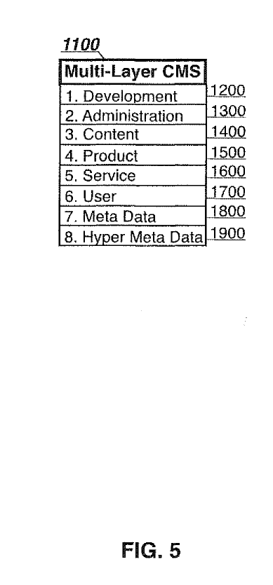

Referring to FIGS. 1 and 5, the back end 10 of the present invention system supports the front end 1000 which includes interaction with the users and purchasers of the products and services depicted on the various media scenes. The present invention multilayer content management system 1100 has eight main functions in the business process of the present invention system which include: (1) maintaining developer code and security 1200; (2) managing administration objects 1300; (3) managing content 1400; (such as movies, television, sports, fashion shows, music, games social events, coming attractions and services); (4) managing product partner interface 1500; (5) managing service partner interface 1600; (6) managing the quality of the user experience 1700; (7) managing Meta Data 1800 and (8) managing Hyper Meta Data 1900.

The present invention content management system is a system providing a collection of procedures used to manage work flow in a collaborative environment. These procedures are preferably computer based. The procedures are designed to do the following: (1) allow for a large number of people to contribute to and share stored data; (2) control access to data based on user roles (defining which information users or user groups can view, edit, publish, etc.); (3) aid in easy storage, search and retrieval of data, (4) reduce repetitive duplicate input, (5) improve the ease of report writing, and (6) improve communications between the system of the present invention and the content, product and service partners.

In the present invention content management system, the stored data 100 can be anything. The system will have a built in redundancy backup of at least two inputs minimum wherein documents, movies, pictures, phone numbers, scientific data etc. are inputted into multiple servers. The content management system computer server or servers are used for storing, controlling, revising, semantically enriching, and publishing documentation. Serving as a central repository, the content management system increases the version level of new updates to an already existing file. Version control is one of the primary advantages of the present invention system.

Referring to FIGS. 1, 5 and 6, included in the content management system is information referred to as a Meta Data 1800. Meta Data 1800 includes information about the product such as a movie, the studio which produced the movie, the director, producer, cast and a synopsis of the movie.

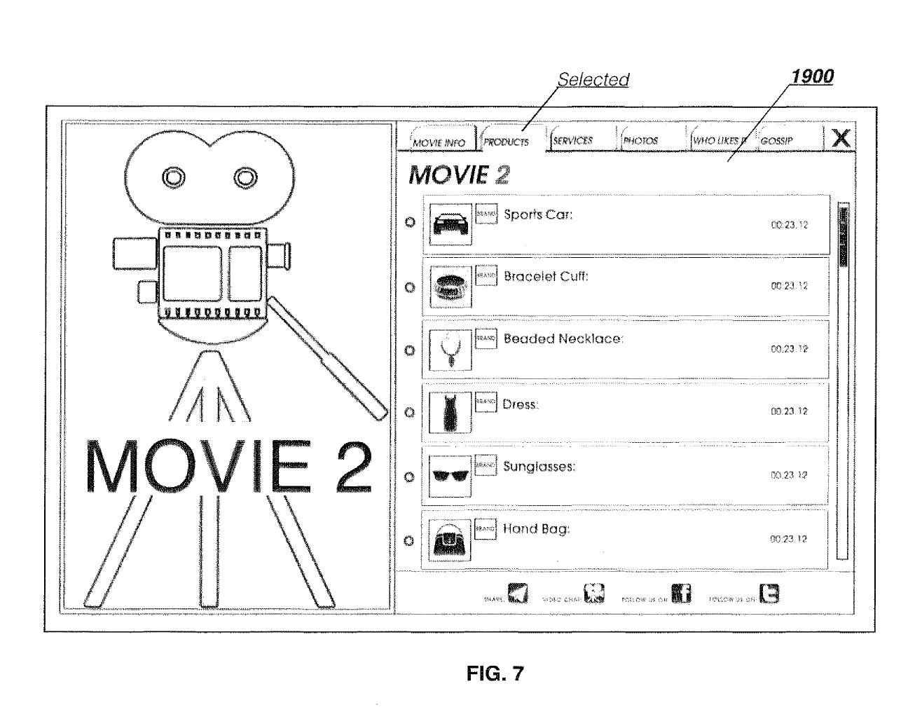

Referring to FIGS. 1, 5 and 7, also included in the content management system is Hyper Meta Data 1900 which includes products, services, photos, gossip and any other related information that the system provider 20 determines is relevant, searchable and available within a scene, the Hyper Meta Data could include product placed in the scene such as a sports car, bracelet, beaded necklace, dress, sunglasses and a handbag. The example illustrated in FIG. 7 is the Hyper Meta Data 1900 of the products tab as selected by the user, and the accompanying list of products available in the movie at the present time stamp. The user may also choose from any other tabs, such as services, to see what else is available for purchase in scenes shown.

As illustrated in FIG. 8, at the user portion 1000 of the present invention, the user will have to be registered with the system provider creating a user profile, the registration including the authorized user's name, billing address, shipping address, encrypted password, credit verification and at least one credit card which has been pre approved to a certain limit for purchase. As additional security, the content data network will have an ever hanging web address, encryption and privacy protection. This also establishes a social page and connection for the user. Similarly profiles are created for the content, in a content profile, and for the partners in a partner profile. The content profile contains the Movie or other content and all of the Meta Data and Hyper Meta Data of the content. For example if the content is a Movie, the Content Profile would contain not only the Movie itself, but also every product and service shown in the Movie, along with the time stamp, pricing, availability, sizing, color options, model options and other purchasing and shipping information. The Partner Profile is where a service or product can interact with the company and the Partner may insert information about its products and services in relation to an identified content. Additionally, the Front End 1000 further contains separate interfaces for each profile type. There is a User Interface by which the User interacts with the System Provider 20, A Content Interface and is the system by which the User interacts with the content and there is a Product and Service Partner Interface by which the user can interface with the products and services available as shown within the content.

In step 1, the user logs in and provides the user's name and password and arrives at a home page. The user selects the content tab such as Movie and then selects a particular movie. In Step 2, the user plays the movie or watches a trailer. The user selects viewing options of low, medium, high definition or 3D. The viewer has the option to select chapters and expand to full screen and or then watch the movie.

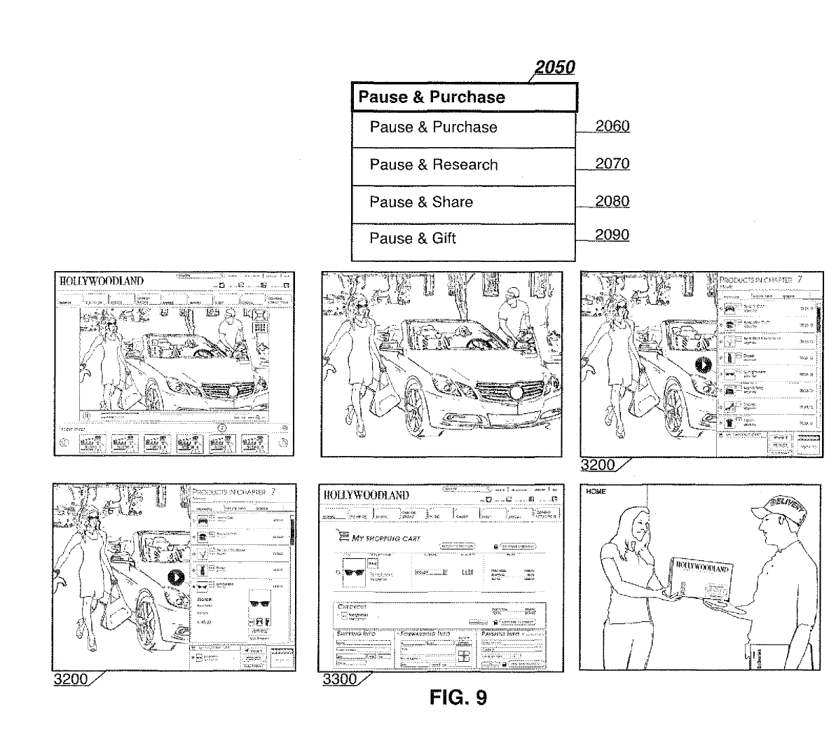

Referring now to FIG. 9, there is shown a fundamental key innovation of the present invention is the cue point to purchase and pause to purchase option 2050. The user utilizes a remote control, computer mouse, voice command, gesture command or other enabling device to stop the running of the media broadcast such as a movie or television show, select an item from a scene, move the item to a checkout window and specify the product including information about the product such as dress size, color, etc. Other options are also available to the User, such as pausing the content to purchase 2060, to Research 2070, to Share 2080, to Gift 2090 and the like. Referring to the summary illustration in FIG. 1, the viewing is from a television set 2100, computer 2200, tablet 2300 or smart phone 2400 to illustrate some examples of Micro transactions 2500 within the content are processed and/or T-commerce is completed. The user pays for the product and by pre-registration, the system provider is advised where to bill and where to ship the product. The process to deliver the product to the user is then set in motion. The user then ends the pause and continues watching the media event. The user may also shop form the shop tab within the user-interface.

An alternative fundamental innovation of the present invention is the pause and research 2070 where the user utilizes a remote control computer mouse or other enabling device to pick out an item from a scene and have it stored in a separate file. The movie continues running and after the movie is completed, the user goes to the storage file to determine whether or not the user wishes to purchase the item and if the user wishes to purchase the item, then the same process is followed to enable the user to selected specifics about the product and arrange for its payment and shipment.

Referring further to FIG. 1, the system provider 20 through the back end components previously described has the content management system which comprises a software tool to manage the work flow in the business of the on-line activities, a data base 100 that is stored inside of the System Provider 20, and an encoding 200 which can organize all the items of the goods and services in the respective entertainment media broadcast by assigning a specific code having numerous numbers and letters in a proprietary sequence so that each item or service in every scene or every media entertainment is categorized to facilitate a user's selection process.

The System Provider 20 through an on-line system communicates viewers 3100 in accordance with various types of the electronic devices, including a computer 2200 a television 2100, a computer tablet 2300, and smart phone 2400. As illustrated in FIG. 1, in a preferred embodiment, the on-line system is a content delivery network 4000 (CDN) which has an ever-changing Web address, wherein the data transferred through the CDN is encrypted so that the privacy protection is well established with multiple redundancies.

As summarized in FIG. 9, the procedures are designed to: a) allow for a large number of people to contribute to and share stored data; b) control access to data, based on user roles to identify which information users or user groups can view, edit and purchase, etc.; c) aid in easy in storage and retrieval of data; e) reduce repetitive duplication input; f) improve the ease of reporting writing and g) improve communication between the company and its content, product and service partners.

In the CMS 1100 (content management system), data can be defined as nearly anything. Data redundancy of n+2 minimum is a standard whereby documents, movies, pictures, phone numbers, scientific data and so forth are stored in multiple servers. In addition, a plurality of the CMS 1100 are frequently used for storing, controlling, revising, semantically enriching, and publishing documentation. The CMS 1100 serves as a central repository to increase the vision levels of new updates to an already existing file. A primary advantage of the CMS 1100 is a version control.

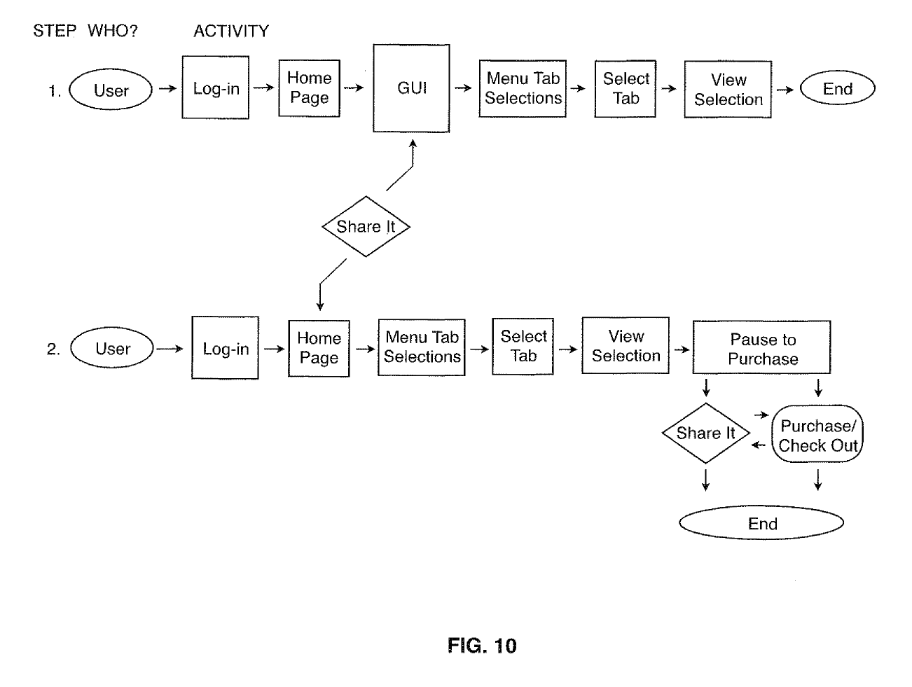

Referring to FIGS. 10, 11 and 12, the home page of the window based execution software which has been activated by the viewer includes a top manual bar for various types of the entertainment shown in the respective icons which are provided by the company to the viewers on-line. As illustrated in FIG. 2, an image of the home page shows two groups of movie icons after the viewer decides to select the movie as his/her preferred entertainment at the moment. Specifically on a body of the image, five movie icons are displayed in a larger scale, as compared with more movie icons in a smaller scale positioned in a lower part of the image. In addition, there are leftward and rightward arrows positioned on the respective left and right sides of the two groups, wherein each arrow allows the viewer to search more movies sent by the present invention system via the CDN 4000.

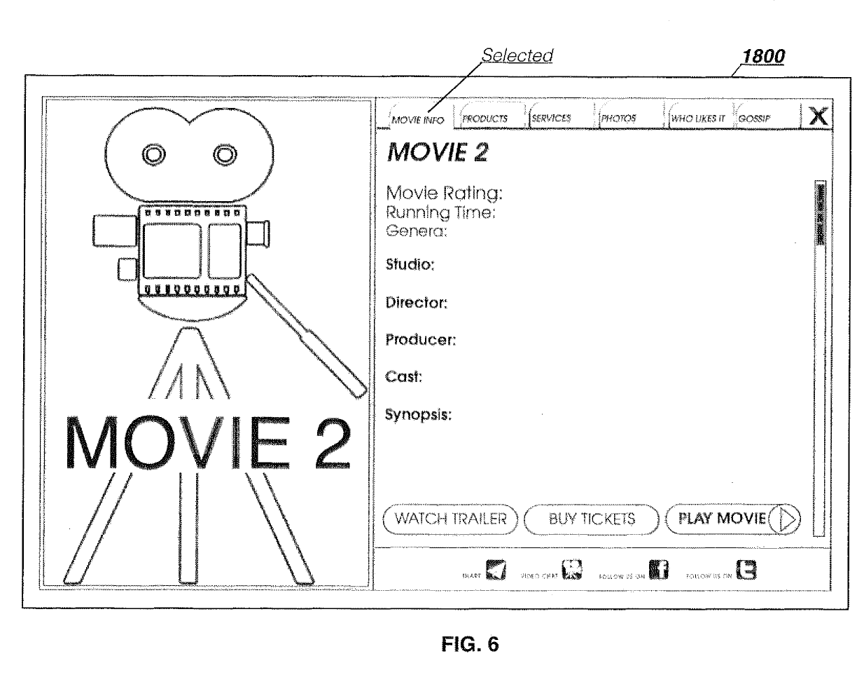

It will be appreciated that, the viewer has an opportunity to know detailed information regarding a particular movie which he/she has chosen. In this case, FIG. 6 shows a dialog box on the home page for the movie 1800 which has been selected, wherein the dialog box can be positioned to superimpose on the image. The information includes a movie rating, running time, studio, director, producer, cast and synopsis. In addition, the dialog box provides two options to the viewer: watch trailer, purchase theater tickets and play movie.

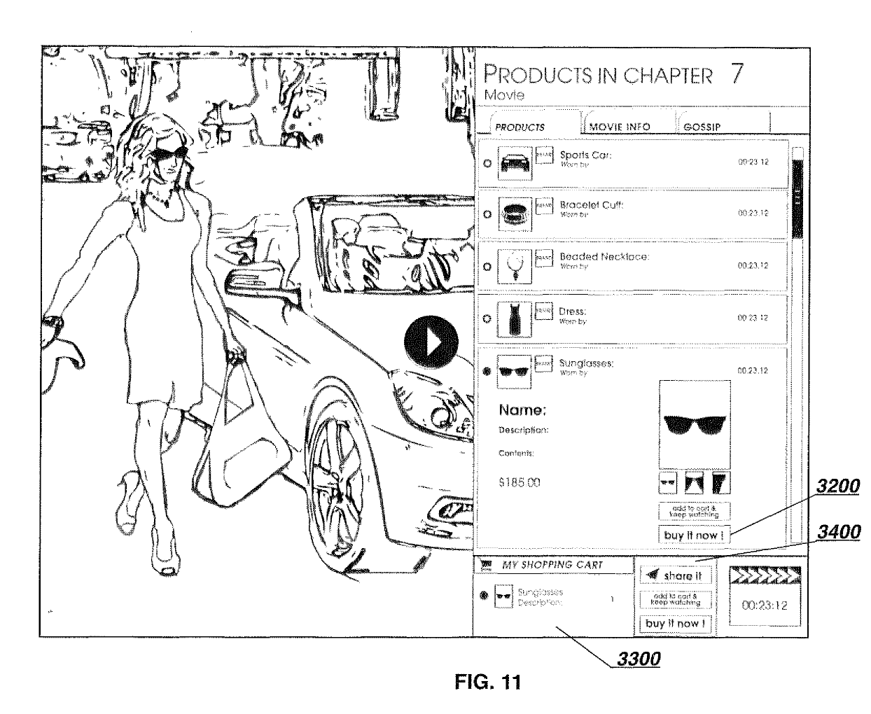

Once the viewer activates the icon of play movie of the dialog box, a sight of the movie is displayed on the body of the home page on the screen of the computer as illustrated in FIG. 11. In a lower position of the home page there are displayed various scenes that are related to the movie, wherein the scenes represent the respective stories of the movie. In this case, the viewer chooses a scene of the movie. In addition, there is a bottom manual bar containing icons of the respective actions for the viewers to take, which include instant buy 3200, select items into my shopping cart 3300, and share information to my friends 3400.

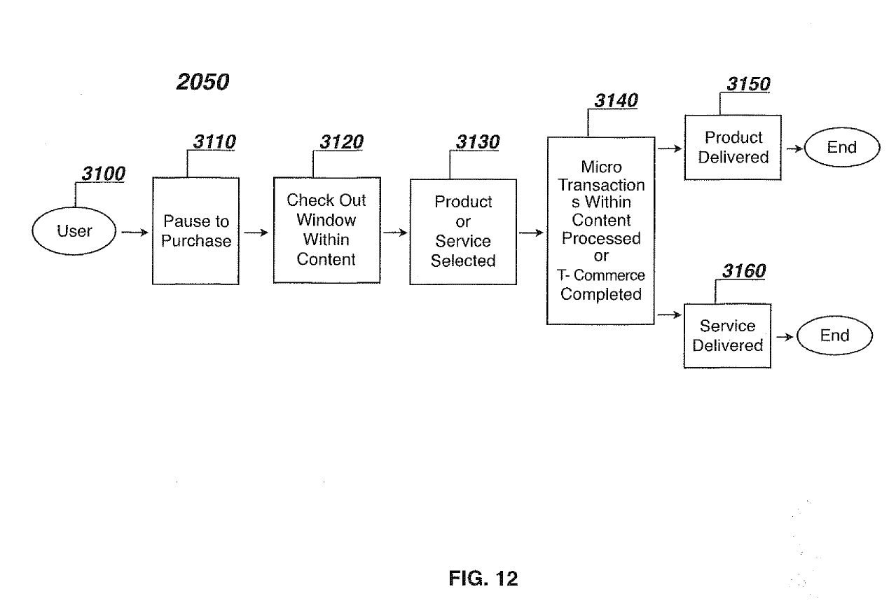

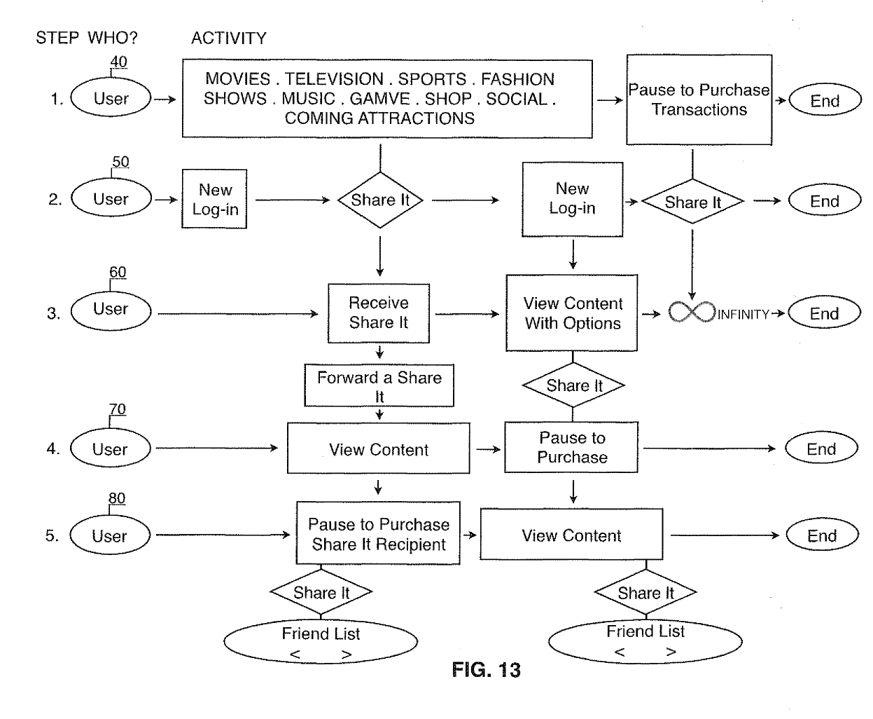

It will be appreciated that, as illustrated before, a key innovation of the present invention is a special feature, the pause and then action functions, example of which are shown in but not limited to FIGS. 12 and 13, and referred to as 2060, 2070, 2080, 2090 which enables the user be able to pause the image of the movie scene if the viewer finds something on the image which he or she is interested in, for example, a sports car 3900 shown in FIG. 11. Then the viewer is able to use a mouse of the computer, a remote control, touch screen, voice command, gesture command or other enabling device to pause and purchase the sports car into one of the three action icons, for example, the instant buy icon 3200. Therefore, this decision of the viewer is electronically transferred to the electronic domain of the physical body of the company, so that a drop shipping of the sports car 100 will be activated after receiving this decision. The sports car 3900 will be delivered to the viewer at his/her physical location that has been previously registered after completing all necessary procedures for this business transaction. Alternatively instead of the pausing and purchasing the car, the viewer can first activate the shop tab, then he or she can purchase or view the sports car 3900.

In the above situation, a stepwise process in purchasing can be summarized, which is illustrated in FIGS. 12 and 13. The viewer 3100 conducts a series of steps, a first step of a cue point to purchase 3110, a second step 3120 of checking out window with content, a third step 3130 of selecting product or service, a fourth step 3140 of micro transactions within content processed or T-commerce completed, a fifth step 3150 that product is delivered if the product is selected in the step 3110, an alternative step 3100 that service is delivered if the service is selected in the step 3110.

It will be appreciated that, the viewer can have the similar action to send the interesting item on the image of the movie to my shopping cart icon 21. In these two cases regarding the instant buy and sending to my shopping cart, the viewer can activate another dialog box to review items that are selected in the movie, which is illustrated in FIG. 11. In the dialog box, it shows the sports car, bracelet cuff, beaded necklace, dress, sunglass and handbag which have been selected when the viewer is watching the movie 10a. Therefore, a stepwise process can be summarized, which is illustrated in FIG. 12.

It will be appreciated that, besides the viewer alone that has the above illustrated business transaction, the viewer 3100 can share his/her information in such business transaction to his or her friends as illustrated in FIG. 13, which is another unique structure and function of the present invention. As illustrated the present invention system and method designs a structure and function regarding an action of pause and share. In application shown in FIG. 13, the viewer can pause and share the sports car 3900, so that friends or at least one friend can receive the information.

Referring to FIG. 13 there is illustrated flow chart for the above discussed action of pause and share. As illustrated, after the moment when the first viewer is in a step of viewing the selection, he or she takes the action in the step to pause and share his selection to a second viewer who completes the log-in procedure and is at a step of loading the home page of the present invention system. Therefore the second viewer is at a step of the pausing to purchase after orderly completing a step of selecting a manual tab, a step of selecting a tab, a step of viewing selected items from his or her interest, wherein the second viewer in his or her electronic domain has the shared items that are sent by the first viewer 40. At the next step, the second user 50 takes action to view or purchase all the selected and shared items. In addition, the second viewer 50 also can take the action of sharing his or her collected items to other viewers in accordance with the system and method of the present invention, which at the same moment enable a plurality of viewers to involve in such on-line business transaction.

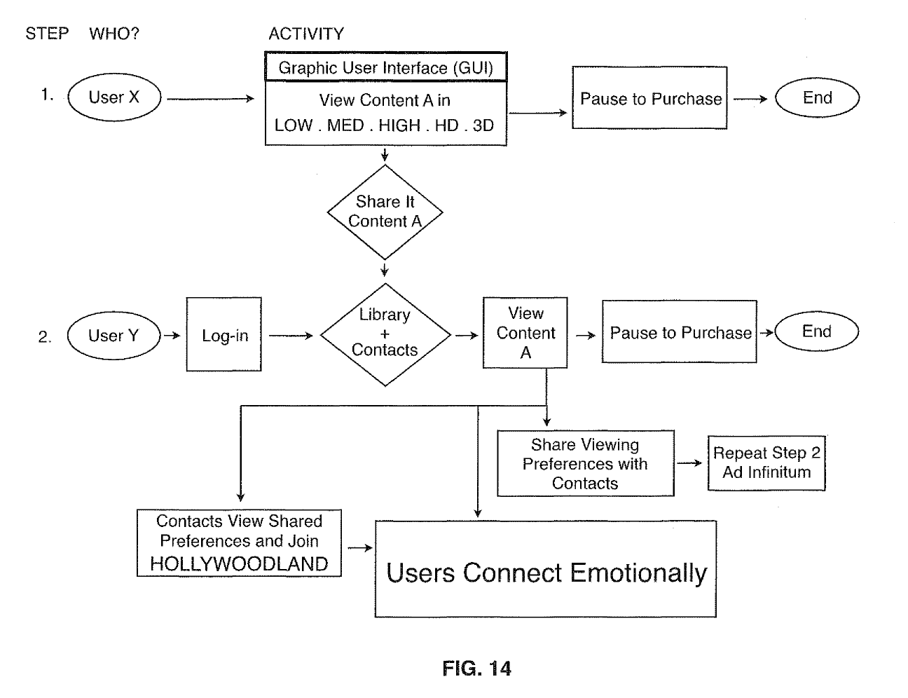

Referring to FIG. 14, there is illustrated flow chart according to connecting user emotionally. Emotional connections are made among users when content is shared and when discussions and forums occur on the social landscape within the System Provider 20.

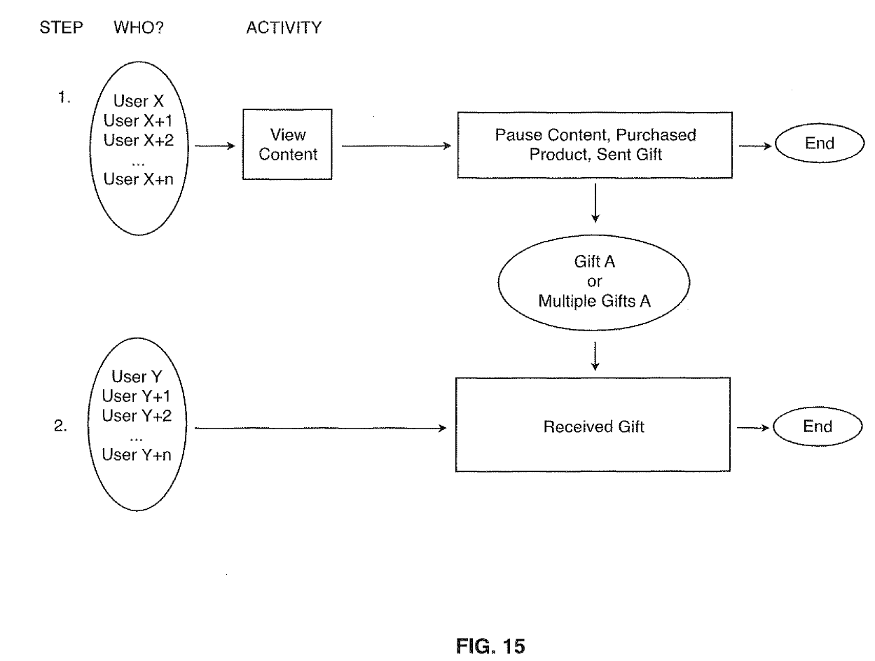

Referring to FIG. 15, there is illustrated a flow chart according to a gift purchase process of users who apply the system and method of the present invention. FIG. 15 illustrates that a single user may send a gift to another single user or may send multiples of the same article to several users. Also encompassed in FIG. 15 is that multiple users may join together and send a gift jointly to another user or join together to send multiple gifts to multiple people. By way of example a group of soccer parents may join in together and send the coach a gift, send each team mate a gift, and/or send the captain or most valuable player a gift. A group gift enables a plurality of viewers to gift one or more friends. A gift can be content, a product or service. A perfect example of a service item in this case is a movie theater ticket.

Of course the present invention is not intended to be restricted to any particular form or arrangement, or any specific embodiment, or any specific use, disclosed herein, since the same may be modified in various particulars or relations without departing from the spirit or scope of the claimed invention herein above shown and described of which the apparatus or method shown is intended only for illustration and disclosure of an operative embodiment and not to show all of the various forms or modifications in which this invention might be embodied or operated.

What is claimed is:

1. A computerized system run by a master provider to facilitate the purchase of goods and services from a public broadcast:
a. a completely comprehensive organization operating system through a computer network that has a complete operating system:
(i) a back end which contains a company database which includes:
(aa) maintaining relationships with content providers and partners who produce and cause to be broadcast a media source of entertainment in a public venue from the group consisting of television, movies, sports, fashion shows, music, games, social events, streaming videos, and playing video games,
(bb) the content partners are key decision makers of major studios, mini majors, and independent film makers, a profile is created for each key decision maker,
(cc) access to the database is granted to the master provider to include the encoding of content to the master provider, facilitating digital distribution contracts with the master provider, access to the master provider's legal department to facilitate digital distribution contracts, uploading information on content partners to the master provider's corporate department, multilayering content management systems, inputting cue point to purchase information, inputting a content delivery network system through a content delivery network to a device agnostic digital access,
(dd) providing contact information pertaining to key decision makers of said product vendor partners to facilitate storage in the database and creating a profile of key decision makers so that key decision makers can upload products for review by the master provider corporate department,
(ee) providing contact information pertaining to key decision makers of said service vendor partner to facilitate storage in the database and creating a profile of key decision makers so that key decision makers can upload services for reviews by the master provider corporate department,
(ff) providing a screen shot of a graphic user interface illustrating menu options of the media source of entertainment from which a user can make a selection,
(gg) inputting completely computerized encoding of every single product and every single service placed in every single scene of each and every media venue publicly broadcast in any way so that anyone wishing to purchase any product or service which is depicted in any way in any scene in any one of the public media venues can do so with a minimum of effort and inconvenience and can do so with complete accuracy to assure that they are purchasing what they have requested to purchase when they view the product or service depicted on the public venue, the encoding is a business process wherein the content is stored on the system corporate server and delivered by means such as a content delivery network to and least one single device agnostic account with content defined as the menu option on the home page of the server or any other database name owned and selected by the master provider,
(ii) the back end of the provider further includes:
(aa) a corporate department including legal affairs, business development, public relations and marketing, and affiliate partnership managers,
(bb) an operations department including a chief operating officer,
(cc) a customer relationship department which includes account managers, customer service and fraud prevention,
(dd) partnership with shipping managers for drop shipping of buyer's product and service managers,
(ee) content acquisition department including a user's experience division,
(iii) the back end of the system supports the front end of the system;
(iv) the front end of the system includes:
(aa) interaction with the users and purchasers of the products and services depicted on the various media scenes,
(bb) a multilayer content management system having eight main functions in the business processes which include
(1) maintaining developer code and security,
(2) managing administration objects,
(3) managing content,
(4) managing product partner interface,
(5) managing service partner interface,
(6) managing the quality of the user experience,
(7) Meta Data
(8) Hyper Meta Data
(cc) the multilayer content management system provides a collection of procedures used to manage work flow in a collaborative environment, the procedures are preferably computer based, the procedures are designed to do the following:
(i) allow for a large number of people to contribute to and share data,
(ii) control access to data based on user roles (defining which information users or user groups can view, edit, and publish),
(iii) aid in easy storage and retrieval of data,
(iv) reduce repetitive duplicate input,
(v) improve the ease of report writing,
(vi) improve communications between the system of the present invention and the content, product and service partners,
b. the computer system of the present invention has a built in redundancy backup of at least two inputs minimum inputted into multiple servers;
c. the content management system computer server or servers are used for storing, controlling, revising, semantically enriching, and publishing documentation, serving as a central repository, the content management system increases the version level of new updates to an already existing file;
d. included in the content management system is information referred to as Meta Data which includes information about the product such as a movie, the studio which produced the movie, the director, producer, cast and a synopsis of the movie;
e. also included in the content management system is Hyper Meta Data which includes products, services, photos, gossip and any other information that the master provider determines is relevant, within a scene, a Hyper Meta Data can include product placed in the scene such as a sports car, bracelet, beaded necklace, dresses, sunglasses and a handbag;
f. at the user portion, the user will have to be registered with the master provider, the registration including the authorized user's name, billing address, shipping address, encrypted password, credit verification and at least one credit card which has been pre-approved to a certain limit for purchases, and as additional security, the content data network will have an ever changing web address, encryption and privacy protection;
(i) the user logs in and provides the user's name and password and arrives at a home page,
(ii) the user selects a content tab such as Movie and then selects a particular movie,
(iii) the user plays the movie or watches a trailer, and the user then selects viewing options of low, medium, high definition and 3D,
(iv) the viewer has the option to select chapters and expand to full screen and or then watch the movie;
g. the user has an option of cue point to purchase and/or pause to purchase:
(i) the user utilizes an enabling device selected from the group consisting of a remote control, computer mouse, voice command, and gesture command to stop the running of the media broadcast such as a movie or television show, select an item from a scene, add the item to a checkout window and specify the product including information about the product such as dress size, color, etc.;
(ii) the viewing is selected from a group consisting of a television set, computer, tablet and smart phone,
(iii) micro transaction within the content are processed and the commerce is completed, the user pays for the product and by pre-registration, the master provider is advised where to bill and where to ship the product and the process to deliver the product or service is set in motion,
(iv) the user then ends the pause and continues watching the media event; and
h. an alternative course of action for the user is a cue point to pause and research:
(i) the user utilizes an enabling device selected from the group consisting of a remote control, computer mouse, voice command and gesture command to pick out an item from a scene and have it stored in a separate storage file, and
(ii) the media event continues running and after the media event is completed, the user goes to the storage file to determine whether or not the user wishes to purchase the item and if the user wishes to purchase the item, then the same process is followed to enable the user to select specifics about the product or service and arrange for its payment and shipment.

2. A computerized system run by a master provider to facilitate the purchase of goods and services from a public broadcast:
a. a completely comprehensive organization operating system through a computer network that has a complete operating system:
(i) a back end which contains a company database which includes:
(aa) maintaining relationships with content providers and partners who produce and cause to be broadcast a media source of entertainment,
(bb) access to the database is granted to the master provider to include the encoding of content to the master provider, facilitating digital distribution contracts with the master provider, access to the master provider's legal department to facilitate digital distribution contracts, uploading information on content partners to the master provider's corporate department, multilayering content media systems, inputting cue point to purchase information, and inputting information on cue point to purchase, pause to purchase and pause and research,
(cc) providing a screen shot of a graphic user interface illustrating menu options of the media source of entertainment from which a user can make a selection,
(dd) inputting completely computerized encoding of every single product and every single service placed in every single scene of each and every media venue publicly broadcast in any way so that anyone wishing to purchase any product or service which is depicted in any way in any scene in any one of the public media venues can do so with a minimum of effort and inconvenience and can do so with complete accuracy to assure that they are purchasing what they have requested to purchase when they view the product or service depicted on the public venue,
(iii) the back end of the system supports the front end of the system,
(iv) the front end of the system includes:
(aa) interaction with the users and purchasers of the products and services depicted on the various media scenes,
(bb) a multilayer content management system having functions selected from the group consisting of maintaining developer code and security, managing administration objects, managing content, managing product partner interface, managing service partner interface, and managing the quality of the user experience,
(cc) the multilayer content management system provides a collection of procedures used to manage work flow in a collaborative environment, the procedures are preferably computer based, the procedures are selected from the group consisting of allowing for a large number of people to contribute to and share data, control access to data based on user roles (defining which information users or user groups can view, edit, and publish), aid in easy storage and retrieval of data, reduce repetitive duplicate input, Improve the ease of report writing, and improve communications between the system of the present invention and the content, product and service partners,
b. the computer system of the present invention has a built in redundancy backup of at least two inputs minimum inputted into multiple servers;
c. at the user portion, the user will have to be registered with the master provider, the registration selected from the group consisting of the authorized user's name, billing address, shipping address, encrypted password, credit verification and at least one credit card which has been pre-approved to a certain limit for purchases, and as additional security, the content data network will have an ever changing web address, encryption and privacy protection;
d. the user performs tasks selected from the group consisting of the user log in and provides the user's name and password and arrives at a home page, the user selects a content tab such as Movie and then selects a particular movie, the user plays the movie or watches a trailer, and the user then selects viewing options of low, medium, high definition and the viewer has the option to select chapters and expand to full screen and or then watch the movie;
e. the user has an option of cue point to purchase and/or pause to purchase:
(i) the user utilizes an enabling device to stop the running of the media broadcast, select an item from a scene, add the item to a checkout window and specify the product including information about the product such as dress size, color, etc.,
(ii) micro transaction within the content are processed and the commerce is completed, the user pays for the product and by pre-registration, the master provider is advised where to bill and where to ship the product and the process to deliver the product or service is set in motion,
(iv) the user then ends the pause and continues watching the media event; and
d. an alternative course of action for the user is a cue point to pause and research:
(i) the user utilizes an enabling device to pick out an item from a scene and have it stored in a separate storage file, and
(ii) the media event continues running and after the media event is completed, the user goes to the storage file to determine whether or not the user wishes to purchase the item and if the user wishes to purchase the item, then the same process is followed to enable the user to select specifics about the product or service and arrange for its payment and shipment.

3. A computerized system run by a master provider to facilitate the purchase of goods and services from a public broadcast in accordance with claim 2, further comprising:
a. the back end further includes:
(i) a company database having material selected from the group consisting of maintaining relationships with content providers and partners who produce and cause to be broadcast a media source of entertainment in a public venue from the group consisting of television, movies, sports, fashion shows, music, games, social events, streaming videos, and playing video games, the content partners are key decision makers of major studios, mini majors, and independent film makers, a profile is created for each key decision maker, providing contact information pertaining to key decision makers of said product vendor partners to facilitate storage in the database and creating a profile of key decision makers so that key decision makers can upload products for review by the master provider corporate department,
(ii) providing contact information pertaining to key decision makers of said service vendor providers to facilitate storage in the database and creating a profile of key decision makers so that key decision makers can upload services for reviews by the master provider corporate department.

4. The computerized system run by a master provider to facilitate the purchase of goods and services from a public broadcast in accordance with claim 2, further comprising:
(i) providing a screen shot of a graphic user interface illustrating menu options of the media source of entertainment from which a user can make a selection.

5. The computerized system run by a master provider to facilitate the purchase of goods and services from the public broadcast in accordance with claim 2, further comprising:
(i.). the. back end of the provider further includes departments selected from the group consisting of: a corporate department including legal affairs, business development, public relations and marketing, and affiliate partnership managers, an operations department including a chief operating officer, a customer relationship department which includes account managers, customer service and fraud prevention, partnership with shipping managers for drop shipping of buyer's product and service managers, content acquisition department including a user's experience division.

6. The computerized system run by a master provider to facilitate the purchase of goods and services from the public broadcast in accordance with claim 2, further comprising:
a. the computer system of the present invention has a built in redundancy backup of at least two inputs minimum inputted into multiple servers;
b. the content management system computer server or servers are used for storing, controlling, revising, semantically enriching, and publishing documentation, serving as a central repository, the content management system increases the version level of new updates to an already existing file;
c. included in the content management system is information referred to as Meta Data which includes information about the product such as a movie, the studio which produced the movie, the director, producer, cast and a synopsis of the movie;
d. also included in the content management system is Hyper Meta Data which includes products, services, photos, gossip and any other information that the master provider determines is relevant, within a scene, a Hyper Meta Data can include product placed in the scene such as a sports car, bracelet, beaded necklace, dresses, sunglasses and a handbag etc.;
e. the user utilizes an enabling device selected from the group consisting of a remote control, computer mouse, voice command, and gesture command to stop the running of the media broadcast such as a movie or television show, select an item from a scene, add the item to a checkout window and specify the product including information about the product such as dress size, color, etc.; and
f. the viewing is selected from a group consisting of a television set, computer, tablet and smart phone.

7. A computerized system run by a master provider to facilitate the purchase of goods and services from a public broadcast:
a. a completely comprehensive organization operating system through a computer network that has a complete operating system:
(i) a back end which contains a company database which includes:
(aa) access to the database is granted to the master provider to include the encoding of content to the master provider, multilayering content media systems, inputting cue point to purchase information, inputting cue point to pause information, inputting a content delivery network system through a content delivery network to a device agnostic digital access,
(bb) providing a screen shot of a graphic user interface illustrating menu options of the media source of entertainment from which a user can make a selection,
(cc) inputting completely computerized encoding of every single product and every single service placed in every single scene of each and every media venue publicly broadcast in any way so that anyone wishing to purchase any product or service which is depicted in any way in any scene in any one of the public media venues can do so with a minimum of effort and inconvenience and can do so with complete accuracy to assure that they are purchasing what they have requested to purchase when they view the product or service depicted on the public venue, the encoding is a business process wherein the content is stored on the system corporate server and delivered by means such as a content data network to and least one single device agnostic account with content defined as the menu option on the home page of the server or any other database name owned and selected by the master provider,
(ii) the front end of the system includes:
(aa) interaction with the users and purchasers of the products and services depicted on the various media scenes,
b. the computer system of the present invention has a built in redundancy backup of at least two inputs minimum inputted into multiple servers;
c. included in the content management system is information referred to as Meta Data which includes information about the public broadcast media;
d. also included in the content management system is Hyper Meta Data which includes products, services, photos, gossip and any other information that the master provider determines is relevant, within a scene, a Hyper Meta Data can include product placed in the scene;
e. at the user portion, the user will have to be registered with the master provider;
f. the user plays the media source of entertainment;
g. the user has an option of cue point to purchase and/or pause to purchase:
(i) the user utilizes an enabling device to stop the running of the media broadcast such as a movie or television show, select an item from a scene, add the item to a checkout window and specify the product,
(ii) the viewing is selected from a group consisting of a television set, computer, tablet and smart phone,
(iii) micro transaction within the content are processed and the commerce is completed, the user pays for the product and by pre-registration, the master provider is advised where to bill and where to ship the product and the process to deliver the product or service is set in motion,
(iv) the user then ends the pause and continues watching the media source of entertainment; and
h. an alternative course of action for the user is a cue point to pause and research:
(i) the user utilizes an enabling device to pick out an item from a scene and have it stored in a separate storage file, and
(ii) the media event continues running and after the media event is completed, the user goes to the storage file to determine whether or not the user wishes to purchase the item and if the user wishes to purchase the item, then the same process is followed to enable the user to select specifics about the product or service and arrange for its payment and shipment.

8. A computerized system run by a master provider to facilitate the purchase of goods and services from a media source of entertainment, comprising:
a. a completely comprehensive organization operating system through a computer network that has a complete operating system:
(i) a back end which contains a company database which includes:
(aa) access to the database is granted to the master provider to include the encoding of content to the master provider, multilayering content media systems, inputting cue point to purchase information, inputting a content delivery network system through a content delivery network,
(bb) providing a screen shot of a graphic user interface illustrating menu options of the media source of entertainment from which a user can make a selection,
(cc) inputting completely computerized encoding of every single product and every single service placed in every single scene of each and every media source of entertainment with complete accuracy to assure that a user is purchasing what they have requested to purchase when they view the product or service depicted on the public venue, the encoding is a business process wherein the content is stored on the system corporate server and delivered by means such as a content data network to and least one single device agnostic account with content defined as the menu option on the home page of the server or any other database name owned and selected by the master provider,
(ii) the front end of the system includes:
(aa) interaction with the users and purchasers of the products and services depicted on the various media scenes,
b. included in a content management system is Hyper Meta Data which includes information about products and services, placed in the scene of a media source of entertainment;
c. at the user portion, the user will have to be registered with the master provider;
d. the user plays the media source of entertainment; and
e. the user has an option of cue point to purchase and/or pause to purchase:
(i) the user utilizes an enabling device to stop the Tuning of the media broadcast such as a movie or television show, select an item from a scene, the item to a checkout window and specify the product,
(ii) the viewing is selected from a group consisting of a television set, computer, tablet and smart phone,
(iii) micro transaction within the content are processed and the commerce is completed, the user pays for the product and by pre-registration, the master provider is advised where to bill and where to ship the product and the process to deliver the product or service is set in motion,
(iv) the user then ends the pause and continues watching the media source of entertainment.

9. The computerized system run by a master provider to facilitate the purchase of goods and services from a media source of entertainment in accordance with claim 8 further comprising:
a. the database includes information on cue point to pause information, and
b. an alternative course of action for the user is a cue point to pause and research:
(i) the user utilizes an enabling device to pick out an item from a scene and have it stored in a separate storage file, and
(ii) the media event continues running and after the media event is completed, the user goes to the storage file to determine whether or not the user wishes to purchase the item and if the user wishes to purchase the item, then the same process is followed to enable the user to select specifics about the product or service and arrange for its payment and shipment.

10. A system comprising:
a. a system provider through back end components having a content management system which comprises a software tool to manage work flow in a business of an on-line activity;
b. a database that is stored inside of a computer with an encoding which organizes all of the items of goods and services depicted in every scene of an entertainment media broadcast by assigning a specific code having numerous numbers and letters in a proprietary sequence so that each good and service in every scene is categorized to facilitate a user's selection process;
c. the system provider through an on-line communication communicates with viewers and users in accordance with various types of electronic devices, with the on-line system being a content delivery network which has an ever changing web address, wherein the data transferred through the content delivery network is encrypted so that privacy protection is well established in multiple redundancies;
d. the user activates a home page which provides entertainment media selections and the user who must be preregistered with the system provider selects a media entertainment event to watch;
e. as the viewer observes certain scenes in the media entertainment event, the user can select a cue point to purchase option wherein the media entertainment event is stopped and the user activates a selection process to purchase an item in a scene; and
f. as the viewer observes a scene in the media entertainment event, the viewer can activate a cue point to pause and place a desired item in a storage area while the media entertainment event is running and can decide whether or not to purchase the item in the storage area after the media entertainment event has been completed.
